(19) United States
(12) Patent Application Publication
(10) Pub. No.: US 2026/0152392 A1
(43) Pub. Date: Jun. 4, 2026

(54) SYSTEMS AND METHODS OF PRODUCING HYDROGEN OR SYNGAS

(71) Applicant: OMC Hydrogen, Inc., Louisville, CO (US)

(72) Inventors: Kent Warren, Broomfield, CO (US); Patrick Vincent, Beaumont, TX (US); Juan Inga, Fort Worth, TX (US); Britt Boughey, Ventura, CA (US)

(73) Assignee: OMC Hydrogen, Inc., Louisville, CO (US)

(21) Appl. No.: 19/385,018

(22) Filed: Nov. 10, 2025

Related U.S. Application Data
(60) Provisional application No. 63/718,467, filed on Nov. 8, 2024.

(51) Int. Cl. C01B 3/36

(52) U.S. Cl. CPC C01B 3/36; C01B 2203/025; C01B 2203/1235

(57) ABSTRACT

Various aspects of this disclosure relate to a method of producing hydrogen or syngas from one or more of H₂O and CO₂ via a thermochemical gas splitting reactor system and the use of inert gases or hydrocarbon gases for reduction. In some embodiments, the disclosure relates to a multi-stage reactor containing multiple fluidized beds where chemical reactions (either oxidation or reduction of a metal oxide material) occur.

### CROSS-REFERENCE TO RELATED APPLICATIONS

This patent application claims priority to U.S. Provisional Ser. No. 63/718,467, , filed 8 Nov. 2024, which is incorporated by reference in its entirety.

### BACKGROUND OF CERTAIN ASPECTS OF THE DISCLOSURE

The imminent shortage of fossil fuels, coupled with expected population growth, has encouraged the transition to an era where society is powered primarily by renewables. Despite this motivation, the rate of renewable energy deployment has been insufficient, largely due to the lack of long-term and cost-effective energy storage.

One solution is to leverage renewable or low carbon sources of energy for the production of hydrogen and syngas, as these intermediates can be readily converted into a myriad of chemical fuels and commodities that are easily transportable and compatible with existing infrastructure. Such a process would consequently allow these—most often—intermittent sources of energy to be stored so that energy can be dispatched on demand to the end user, regardless of the time of day or geographic location. Therefore, it is desirable to safely, sustainably, and affordably produce hydrogen or syngas in a manner that is amenable to large scale commercial operations.

### BRIEF SUMMARY OF SOME ASPECTS OF THE DISCLOSURE

The present disclosure relates to systems and methods of producing hydrogen or syngas from one or more of H₂O and CO₂ via a multi-stage, thermochemical gas splitting reactor system and the use of inert gases or hydrocarbon gases for reduction. Depending on the gases used, and their sources, the products can be considered “green” or “blue” hydrogen and/or syngas.

In some embodiments, the multi-stage thermochemical gas splitting reactor systems for producing hydrogen or syngas include: a pressure vessel, an inlet distributor, an oxidation reactor, a reduction reactor, a bottom grid plate, a plurality of reactor stages, including a plurality of reactor stage grid plates configured to permit gas to flow from a bottom to a top of each reactor, a plurality of diplegs configured to transfer solids from one stage to a next stage, and a plurality of fluidized beds of metal oxide powder, each bed located above each reactor stage grid plate and configured to perform a chemical reaction fluidized by an oxidizing agent or a reducing agent.

In some embodiments, a fluidized bed of metal oxide powder is contained above each grid plate. In some embodiments, the systems include a reactor wall, including a susceptor, a refractory brick, a plurality of induction coils, and a steel exterior surface. In some embodiments, the inlet distributor and the bottom grid plate provide gas distribution and pressure drop to encourage bed fluidization. In some embodiments, the diplegs on each stage move solids from the top to the bottom of the reactor. In some embodiments, the grid plates hold the solids in each stage for a predetermined period of time to establish equilibrium. In some embodiments, the systems include a cyclone separator. The cyclone separator can be internal or external to the system. In some embodiments, the cyclone separator separates outgoing gas and solids, returning the solids back into the system while letting the gas leave the reactor. In some embodiments, the oxidizing agent is H₂O, O₂, or CO₂. In some embodiments, the reducing agent is N₂, Argon, or hydrocarbon. In some embodiments, each reactor includes at least one reactor stage.

In some embodiments, the methods of producing hydrogen or syngas in a multi-stage thermochemical gas splitting reactor system with an oxidation reactor and a reduction reactor include: providing an oxygen-deficient solid at a cyclone separator into the oxidation reactor, moving the solid downward through in a plurality of beds fluidized by steam in a plurality of reactor stages in an oxidation reactor tower; exposing the solid to oxygen via contact with H₂O and/or CO₂, moving the solid towards the bottom of the oxidation reactor tower and to the reduction reactor with a fresh inert or hydrocarbon gas stream, separating the solid from the carrier gas with a cyclone separator of the reduction reactor; moving the oxygen-rich solid into the reduction reactor, exposing the oxygen-rich solid to an oxygen-deficient high-temperature reducing environment of mostly inert and/or hydrocarbon gas, releasing oxygen from the solid as it moves through the reduction reactor and interacts with inert gas or reacts with the hydrocarbon gas to form 1) CO; 2) H₂; 3) CO₂ and H₂O, or 4) a combination of CO, H₂, CO_{2,} and H₂O, and recycling the solid back into the top of the oxidation reactor where it will encounter a stream comprised of H2 and H2O, CO and CO2, or H2 and H2O, CO and CO2, or H2, CO, H2O and CO2.

In some embodiments, the methods include heating and moving gases through fluidized beds to facilitate a reaction with metal oxide powder. In some embodiments, the methods include providing gas distribution and pressure drop to encourage bed fluidization with an inlet distributor and a bottom grid plate. In some embodiments, the methods include moving the solid from a first stage to a second stage with a dipleg, and flowing gas with a grid plate from the bottom of the reactor tower to the top of the reactor tower. In some embodiments, the methods holding the solid in each stage for a predetermined period of time to establish an equilibrium in the system. In some embodiments, the methods fluidizing a plurality of fluidized beds of metal oxide powder by an oxidizing agent or a reducing agent.

There are other novel aspects and features of this disclosure. They will become apparent as this specification proceeds. Accordingly, this brief summary is provided to introduce a selection of concepts in a simplified form that are further described below in the detailed description. The summary and the background are not intended to identify key concepts or essential aspects of the disclosed subject matter, nor should they be used to constrict or limit the scope of the claims. For example, the scope of the claims should not be limited based on whether the recited subject matter includes any or all aspects noted in the summary and/or addresses any of the issues noted in the background.

### BRIEF DESCRIPTION OF THE DRAWINGS

The preferred and other embodiments are disclosed in association with the accompanying drawings in which:

FIG. 1 is a schematic drawing of an embodiment of a thermochemical gas splitting multi-stage reactor system in accordance with aspects of the present disclosure.

FIG. 2 is a sectional view of an embodiment of a reactor wall in a thermochemical gas splitting multi-stage reactor system in accordance with aspects of the present disclosure.

FIG. 3 a flowchart of example operations for a method of producing hydrogen or syngas via a thermochemical gas splitting multi-stage reactor system.

### DETAILED DESCRIPTION

In the following description, for the purposes of explanation, numerous specific details are set forth to provide a thorough understanding of the present invention. It will be apparent, however, to one skilled in the art that the present invention may be practiced without some of these specific details. For example, while various features are ascribed to particular implementations, it should be appreciated that the features described with respect to one implementation may be incorporated with some other implementations as well. Similarly, however, no single feature or features of any described implementation should be considered essential to the invention as some implementations of the invention may omit such features.

Thermochemical gas splitting is a process where a gas molecule is broken down into its constituent elements using heat energy and a series of chemical reactions. A molecule, such as water, can be “split” apart into hydrogen and oxygen through a closed-loop cycle. Thermochemical splitting relies solely on high temperatures (e.g., 500° C.-2,000° C.) for the chemical reactions to break apart the gas molecule. The high temperatures can be generated by concentrated solar power, using waste heat from advanced nuclear reactors, electrical inductive heating, or other methods. For example, concentrated solar power can be used as the heat source to produce desired gas products, such as hydrogen. It is desirable to use waste or recovered heat as much as possible to increase overall process competitiveness. Thermochemical gas splitting is a sustainable method where the chemicals used to split the gas molecule are regenerated and reused within each cycle.

Metal oxides may be used in thermochemical cycles as materials for the reactions at high temperatures. A metal oxide may be heated to release oxygen and become a reduced metal oxide in a reduction step. In an oxidation step, the reduced metal oxide can be exposed to water, which reacts to produce hydrogen gas and creates the metal oxide.

Renewable sources of heat can drive a thermochemical reaction, which produce separate streams of oxygen and either green hydrogen or syngas (CO+H2), depending on the inputs into a reactor system. The resultant green hydrogen or syngas can then be used in various processes.

Syngas (CO+H2) has nearly a century of commercial uses being converted into higher value hydrocarbons such as methanol, jet and diesel fuels, gasoline, waxes, lubricants, and can even be fermented into alcohols. However, syngas is almost exclusively derived from coal or natural gas. When syngas is produced cleanly, it enables clean production of the products mentioned previously. Hydrogen is widely used throughout major industries such as petroleum and biofuels refining and ammonia production. When produced cleanly, hydrogen can be used as a fuel to help decarbonize existing industries as well as potential emerging uses such as transportation and steelmaking.

Thermochemical gas splitting can achieve high energy conversion efficiency and produce clean hydrogen with no greenhouse gas emissions. However, there are challenges with this process. It can be difficult to achieve, maintain, and house thermochemical cycles, which require high temperatures and efficient and durable reactant materials.

The disclosed technology relates to systems and methods of thermochemical processes to produce green hydrogen or green syngas from one or more of H₂O and CO₂ via a thermochemical gas splitting reactor system. Specifically, the disclosed technology includes systems and methods related to multi-stage reactor systems that can withstand high temperatures for operation and repeated redox cycles.

In some embodiments, the disclosure relates to multi-stage reactor systems containing multiple fluidized beds where chemical reactions (either oxidation or reduction of a metal oxide material) occur. In some embodiments, the multi-stage reactor system includes an extremely well-insulated, refractory-lined steel pressure vessel in which gases can be heated and passed through fluidized beds to facilitate a reaction with the metal oxide powder that fluidizes in the beds. In some embodiments, the multi-stage reactor system includes two different reactors (one for oxidation and one for reduction). The disclosed systems herein were driven by a potential reduction in overall nitrogen usage and associated operational expenses of the process.

Various kinds of reactors (e.g., a fluidized bed reactor, a packed bed reactor, a moving bed reactor, a transport reactor, etc.) may be used in the reactor system to facilitate thermochemical reactions.

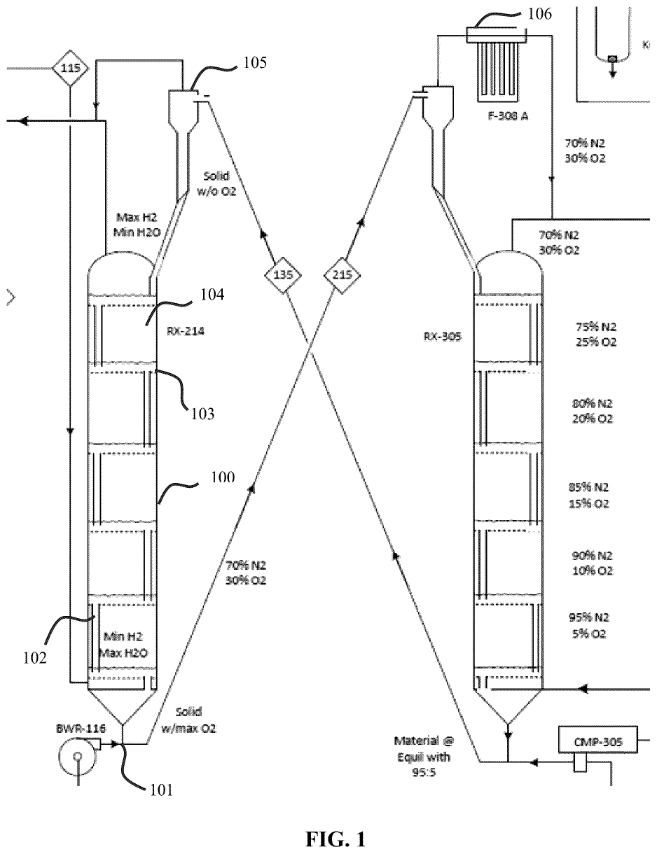

FIG. 1 is a schematic drawing of an embodiment of a multi-stage reactor system. The system includes a well-insulated, refractory-lined steel reactor pressure vessel 100 in which gases can be heated and passed through fluidized beds to facilitate a reaction with the metal oxide powder that fluidizes in the beds. In FIG. 1, the system includes two reactors: one reactor for oxidation and one reactor for reduction.

In the system, a five-stage “oxidation reactor” is shown on the left of FIG. 1. A plurality of beds of metal oxide powder are fluidized by an oxidizing agent (e.g., H₂O, O₂, CO₂, etc.) flowing from the bottom to the top, counterflow to the direction of the powder that is flowing from the top to the bottom. FIG. 1 shows water (H₂O) being converted into hydrogen (H₂) and oxygen (O₂), with the O₂ being carried out along with the solids. H₂ is then separated from the leftover H₂O to form a hydrogen product. In some embodiments, the oxidizing agent may be a recycled stream from other processes (specifically, methanol synthesis from syngas generates an H2O stream containing minor impurities for possible recirculation into the oxidation reactor).

In the system in FIG. 1, a five-stage “reduction reactor” is shown on the right. The beds of metal oxide powder are fluidized by a reducing agent (e.g., N₂, Ar, CO, CH4, light ends, etc.) flowing from the bottom to the top, counterflow to the direction of the powder that is flowing from the top to the bottom. FIG. 1 shows nitrogen being used to separate O₂ from the solids. In some embodiments, the reducing agent may be a recycled stream from other processes (specifically, Fischer-Tropsch synthesis from syngas generates a light hydrocarbon stream for possible recirculation into the reduction reactor).

The reactor system can include an inlet distributor (101), diplegs (102), grid plates (103) (e.g., perforated plate, bubble cap tray, frit, etc.), fluidized beds of solid oxide material contained above each grid plate (104), an external cyclone separator (105) for solids recirculation, and a filter (106) for solids removal from gas.

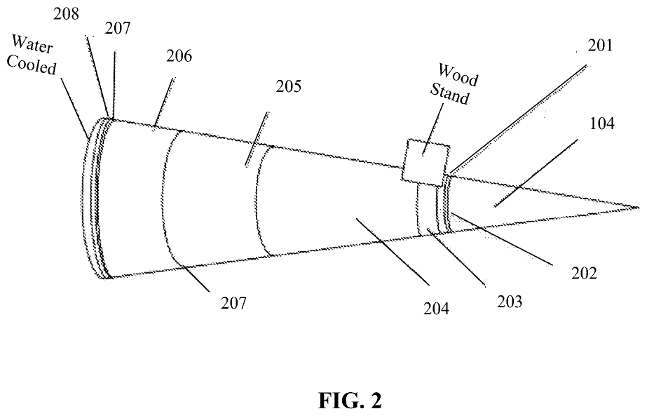

In some embodiments, the reactor system also includes a reactor wall inclusive of susceptor (for heating), refractory brick, induction coils, and a steel exterior, as shown in FIG. 2. More specifically, in some embodiments, the susceptor protects the refractory insulation from degradation via particle or powder bombardment. The bed of active material either reduces or oxidizes according to an extent of reaction and relative atmosphere.

In some embodiments, the system includes reactor components lined with sufficient refractory insulation to mitigate conductive heat losses, ensure highly efficient heat-to-fuel conversion and provide structural support for an induction coil. The induction coils deliver (e.g., via a susceptor) process heat to the reactor.

In some embodiments, the system includes a well-insulated, refractory-lined steel-enclosed fluidized or packed bed pressure vessel or reactor, in which heated process gases can be delivered to facilitate the desired thermochemical reactions in a fluidized bed configuration. The steel provides structural support for the reactor components and ensures that the system can contain expected pressures. In some embodiments, the steel enclosure may be water cooled.

The inlet distributor 101 and bottom grid plate 103 may provide gas distribution and enough pressure drop (e.g., ΔPgrid≈0.3 ΔPbed) to encourage bed fluidization. The fluidized bed region is configured such that, at process temperatures and pressures, the particles fluidize at a mass-specific flow rate in a range of approximately 1 mL min⁻¹ g⁻¹-100 mL min⁻¹ g⁻¹.

The diplegs 102, which convey solids captured by the cyclone to the fluidized bed 104 while preventing gas mixing. For example, the diplegs on each stage may move solids from the top to the bottom, transferring solids from one stage to the next. The grid plates 103 hold the solids in each stage for some period of time so that equilibrium can approximately be established and allow gas to flow from top to bottom. Rough equilibrium estimates are shown for the reduction reactor in FIG. 1.

The number of stages can vary, and may be +/−five. The optimal configuration may vary. In some embodiments, the oxidation reactor may be fewer stages. Each bed may contain solids that are performing a chemical reaction.

The cyclone separator may separate outgoing gas and solids, returning the solids back into the system while letting the gas leave the reactor.

FIG. 2 is a section of an embodiment of a reactor wall in a multi-stage reactor system. In some embodiments, the systems and methods include a well-insulated, refractory-lined steel-enclosed fluidized or packed bed pressure reactor, in which heat can be delivered to facilitate the desired thermochemical reactions in a fluidized bed configuration.

In some embodiments, the systems and methods include incorporation of inductive heating into the systems for the application of thermochemical gas splitting. Commercially available resistive heating element variants, despite being a more conventional approach to supplying electrical heat, are not able to tolerate both reducing and oxidizing atmospheres. As a result, for thermochemical gas splitting technologies, such heating elements would need to be shielded, either via an environmental barrier coating or via insertion into a ceramic tube, both of which introduce additional design complexity at large scales. Inductive heating, on the other hand, allows for the use of susceptors (e.g., boron carbide) that are readily scalable, are stable under both atmospheres, and can efficiently radiate heat to the reacting media.

As shown in FIG. 2, the wall may include layers of one or more of the susceptor 201, refractory brick 205, mortar 207, induction coil 203, gap (containing no material) 204, and steel exterior 208. In some embodiments, there are multiple layers of refractory brick 205 and 206 as shown in FIG. 2. The susceptor (or hard face) protects the refractory insulation from degradation via particle or powder bombardment. The bed of active material either reduces or oxidizes according to an extent of reaction and relative atmosphere. In some embodiments, gases and solids inside the reactor system may be heated through radiation from the susceptor surface.

In some embodiments, the reactor components are lined with sufficient refractory insulation to mitigate conductive heat losses, ensure highly efficient heat-to-fuel conversion and provide structural support for an induction coil. For example, refractory brick insulation may minimize heat loss, support the coils, and allow the exterior to be made of inexpensive steel.

The induction coil delivers (e.g., via a susceptor) process heat to the reactor. The steel provides structural support for the reactor components and ensures that the system can contain expected pressures. In some embodiments, the steel enclosure may be water cooled.

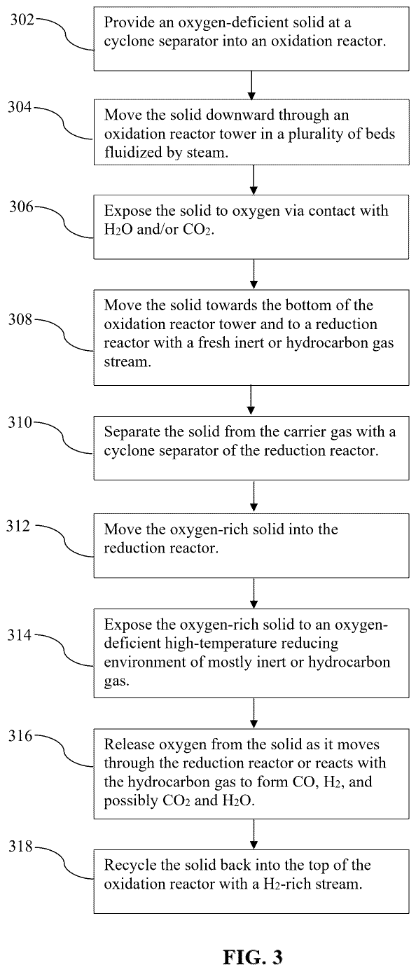

FIG. 3 is a flowchart of example operations for a method of producing hydrogen or syngas via a multi-stage reactor system. In an operation 302, an oxygen-deficient solid begins at the cyclone separator and falls into the oxidation reactor. In an operation 304, the solid gradually moves downward through the system in a bed fluidized by steam 115 in FIG. 1. The solid movement can vary, depending on particle size. As the solid moves through the different beds of the tower, the solid will eventually come into contact with enough oxygen (via contact with H₂O, CO₂, or both) and absorb it to become oxygen-rich in an operation 306.

The solid will gradually move towards the bottom of the tower and then be carried over to the reduction reactor with a fresh inert or hydrocarbon gas stream 215 in FIG. 1 in an operation 308. The cyclone separator of the reduction reactor separates the solid from the carrier gas in an operation 310 and allows the solid to fall into the reactor in an operation 312. The oxygen-rich solids encounter an oxygen-deficient high-temperature reducing environment of mostly inert or hydrocarbon gas in an operation 314. As a result, the solid releases oxygen as it moves through the reactor or reacts with the hydrocarbon gas to form CO, H₂, and possibly CO₂ and H₂O in an operation 316. By the time the solid reaches the bottom of the reactor, it has released most of the oxygen it had previously absorbed and is ready for recycle back into the top of the oxidation reactor in an operation 318.

It should be appreciated that alternative embodiments besides the embodiments discussed herein exist, and the following examples are contemplated to deter attempts to design around this disclosure. For example, in some embodiments, the overall number of stages can be adjusted. FIG. 1 shows five stages in both oxidation and reduction reactors, however more or less stages may be used.

In some embodiments, the grid plate designs may be varied or consistent from stage to stage, and could include, but are not limited to, designs of perforated plate, bubble cap tray, half-pipe, spill-over weir, etc. In some embodiments, diplegs may or may not have mechanical seals of some type. In some embodiments, the cyclones can be external or internal. In some embodiments, there may be both a primary and secondary cyclone separator.

In some embodiments, the exterior wall of the reactor may or may not be externally cooled.

These examples of design alternatives are not exhaustive.

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

Features implementing functions may also be physically located at various positions, including being distributed such that portions of functions are implemented at different physical locations. Also, as used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

The above specification, examples, and data provide a complete description of the structure and use of exemplary implementations of the invention. Since many implementations of the invention can be made without departing from the spirit and scope of the invention, the invention resides in the claims hereinafter appended. Furthermore, structural features of the different implementations may be combined in yet another implementation without departing from the recited claims. While embodiments and applications of this invention have been shown, and described, it would be apparent to those skilled in the art having the benefit of this disclosure that many more modifications than mentioned above are possible without departing from the inventive concepts herein. The invention, therefore, is not to be restricted except in the spirit of the appended claims.

1. A method of producing hydrogen or syngas in a multi-stage thermochemical gas splitting reactor system with an oxidation reactor and a reduction reactor, comprising:
providing an oxygen-deficient solid at a cyclone separator into the oxidation reactor;
moving the solid downward through in a plurality of beds fluidized by an oxidizing gas in a plurality of reactor stages in an oxidation reactor tower;
exposing the solid to oxygen via contact with H₂O and/or CO₂;
moving the solid towards the bottom of the oxidation reactor tower and to the reduction reactor;
separating the solid from the carrier gas with a cyclone separator of the reduction reactor; moving the oxygen-rich solid into the reduction reactor;
exposing the oxygen-rich solid to an oxygen-deficient high-temperature reducing environment of mostly inert or hydrocarbon gas;
releasing oxygen from the solid as it moves through the reduction reactor and interacts with inert gas or reacts with the hydrocarbon gas to form 1) CO; 2) H₂; 3) CO₂ and H₂O; or 4) a combination of CO, H₂, CO₂, and H₂O; and
recycling the solid back into the top of the oxidation reactor where it will encounter a stream comprised of H₂ and H₂O, CO and CO₂, or H₂ and H₂O, CO and CO₂, or H₂, CO, H₂O and CO₂.

2. The method of claim 1, further comprising:
heating and moving gases through fluidized beds to facilitate a reaction with metal oxide powder.

3. The method of claim 1, further comprising:
providing gas distribution and pressure drop to encourage bed fluidization with an inlet distributor and a bottom grid plate.

4. The method of claim 1, further comprising:
moving the solid from a first stage to a second stage with a dipleg; and
flowing gas with a grid plate from the bottom of the reactor tower to the top of the reactor tower.

5. The method of claim 1, further comprising:
holding the solid in each stage for a predetermined period of time to establish an equilibrium in the system.

6. The method of claim 1, further comprising:
fluidizing a plurality of fluidized beds of metal oxide powder by an oxidizing agent or a reducing agent.

7. The method of claim 6, wherein the oxidizing agent is H₂O, O₂, or CO₂.

8. The method of claim 6, wherein the reducing agent is N₂, Argon, or hydrocarbon.

9. The method of claim 1, wherein the system includes a refractory-lined steel pressure vessel.

10. A multi-stage thermochemical gas splitting reactor system for producing hydrogen or syngas, comprising:
at least one pressure vessel having an inlet distributor, a bottom grid plate, and a plurality of reactor stages, including:
a plurality of reactor stage grid plates configured to permit gas to flow from a bottom to a top of each reactor;
a plurality of diplegs configured to transfer solids from one stage to a next stage; and
a plurality of fluidized beds of metal oxide powder, each bed located above each reactor stage grid plate and configured to perform a chemical reaction fluidized by an oxidizing agent or a reducing agent.

11. The system of claim 10, wherein a fluidized bed of metal oxide powder is contained above each grid plate.

12. The system of claim 10, further comprising:
a reactor wall, including:
a susceptor;
a refractory brick;
a plurality of induction coils; and
a steel exterior surface.

13. The system of claim 10, wherein the inlet distributor and the bottom grid plate provide gas distribution and pressure drop to encourage bed fluidization.

14. The system of claim 10, wherein the grid plates hold the solids in each stage for a predetermined period of time to establish equilibrium.

15. The system of claim 10, further comprising:
a cyclone separator.

16. The system of claim 15, wherein the cyclone separator is external to the system.

17. The system of claim 15, wherein the cyclone separator separates outgoing gas and solids, returning the solids back into the system while letting the gas leave the reactor.

18. The system of claim 10, wherein the oxidizing agent is H₂O, O₂, or CO₂.

19. The system of claim 10, wherein the reducing agent is N₂, Argon, or hydrocarbon.

20. The system of claim 10, wherein the pressure vessel is a refractory-lined steel pressure vessel.

21. The system of claim 10, wherein the reactor system comprises an oxidation pressure vessel and a reduction pressure vessel.
